(19) United States
(12) Patent Application Publication
(10) Pub. No.: US 2015/0046331 A1
(43) Pub. Date: Feb. 12, 2015

(54) MOBILE P2P - CROSS BORDER PAYMENTS

(71) Applicant: MasterCard International Incorporated, Purchase, NY (US)

(72) Inventors: Akshat Gupta, Vernon, CT (US); Shawn Hagmeier, St. Peters, MO (US)

(21) Appl. No.: 14/455,009

(22) Filed: Aug. 8, 2014

Related U.S. Application Data
(60) Provisional application No. 61/864,197, filed on Aug. 9, 2013.

(51) Int. Cl. G06Q 20/32; G06Q 20/40

(52) U.S. Cl. CPC G06Q 20/322; G06Q 20/40
USPC 705/44; 705/39

(57) ABSTRACT

Systems and methods include receiving a request for a funds transfer to transfer funds from Sender to a Recipient, the request including a transfer amount and, as an identifier of the recipient, a destination mobile telephone number associated with the recipient; translating, based at least in part on a record of a mapping of the destination mobile telephone number to an account associated with the recipient, the destination mobile telephone number to a destination account number; and routing the funds transfer as a payment transaction using the destination account number.

### BACKGROUND

Embodiments disclosed herein relate to remittance systems. In particular, some embodiments relate to methods, apparatus, systems, means and computer program products for implementing a remittance system on the basis of an international payment card system.

Many individuals regularly send money to family or friends across international borders. The total annual volume of international person-to-person remittances is measured in the hundreds of billions of U.S. dollars (including transactions that involve U.S. dollars and transactions that do not involve U.S. dollars) and is increasing from year to year.

Existing remittance systems do not allow a person to person international remittance, that may originate from a bank account or a mobile wallet of the sender, to be sent directly to a mobile phone number associated with a payment account.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram of a system, according to some embodiments;

FIG. 2 is an illustrative depiction of a process that illustrates an international remittance system provided according to some aspects of the present disclosure;

FIG. 3 is a block diagram of a system, in accordance with some embodiments;

FIG. 4 is an illustrative depiction of a process that illustrates an international remittance system provided according to other aspects of the present disclosure; and

FIG. 5 is a diagram of a computing device, in accordance with some embodiments.

### DETAILED DESCRIPTION

In general, and for the purpose of introducing concepts of embodiments of the present invention, an international remittance system is based on a payment card account system such as that operated by MasterCard International Inc., the assignee hereof. Pursuant to some embodiments, a remittance may involve a “sender” and a “recipient”. Pursuant to some embodiments, cross-border person-to-person remittances or funds transfers may be performed between a recipient to receive funds from another individual directly into their account more quickly, safely and easily. Further, embodiments allow such remittances to be made without needing to visit an agent location or use cash to load funds. For convenience, an embodiment of the present invention based on the MoneySend system operated by MasterCard International Inc. will be described herein, however, those skilled in the art will appreciate that other systems or platforms may utilize features of the present invention with similarly desirable results.

Pursuant to some embodiments, a sender is able to send funds directly into a receiver's/recipient's Mobile Money stored value account (SVA) account using the recipient's mobile phone number as the identifier where this mobile phone number is linked to a primary account number (PAN). In some aspects, this will eliminate the need for the Sender to provide a 16-digit primary account number (“PAN”) which the Sender may lose, fat-finger or compromise its security. A sender enjoys additional benefits of ensuring transparency of fees, certainty of timing and guaranteed receive amount.

Pursuant to some embodiments, a recipient is able to have funds deposited directly into a Mobile Money SVA account avoiding the need for the recipient to travel to a Money Transfer operator's location to collect the funds or having the need to provide their PAN to the sender overcoming any issues relating to trust, fraud and security.

For convenience, and ease of exposition, a number of terms will be used herein. For example, a particular embodiment of the present invention is described for illustration which is referred to as the “MasterCard MoneySend” program. The use of this particular illustrative example is not intended to be limiting, and embodiments may be used in conjunction with other payment networks and payment systems. As used herein, the term “Originating Institution” (OI) refers to an entity (such as a financial institution) that originates both a Funding Transaction and a MasterCard MoneySend Payment Transaction at the request of and by agreement with a Sender.

A “Processor” is a financial institution that processes credit/debit/prepaid card transactions or a platform provider who does so on behalf of a financial institution. A “Receiving Institution” (RI) is an entity that approves a MoneySend Payment Transaction and makes the funds available to the Recipient. A “Program Manager” is an entity and the owner of a prepaid stored value card program. The program manager typically is responsible for establishing relationships with processors, financial institutions, payment networks and distributors and for establishing account(s) at bank, including for example a direct deposit account and a pooled account such as a GreenDot® account. “MPS” is an entity that operates a Mobile Payments Gateway (MPG), which is the platform that connects the “mobile network operators” (MNOs) to MasterCard. An MPS may also provide the Mobile Wallet, Service Manager and the Switch entities.

A “mobile payment gateway” (MPG) is an entity or system allowing communication between MNOs and a payment system (such as the Banknet system operated by MasterCard International Incorporated). A “Mobile Wallet” is an electronic account held on a mobile phone that can be used to store and transfer value. It can, for example, hold information identifying one or more payment devices (such as credit, debit, or prepaid cards) registered by the wallet user. The “wallet” may be referred to herein generally as a stored value account (SVA).

A “MasterCard Mobile Service Manager” (MMSM) is a set of services that enable consumer-initiated mobile payments. In some embodiments, MMSM is targeted to MasterCard issuers and other consumer-facing entities, which have the flexibility to select from, for example, one or more configurations (MMSM-Service Manager or MMSM-Gateway).

As used herein, the term “MPS MoneySend Connector” refers to a single MPG “interface” between a MPG and a MoneySend Card Mapping Database. The term “Mobile Network Operator” (MNO) refers to a provider of wireless communications services that owns or controls all the elements necessary to provide cellular services to an end consumer.

The term “MoneySend Platform” refers to a system that enables customer financial institutions to use the global network and card products of a payment network (offered, by MasterCard) to transfer funds from one consumer to another. The “MoneySend Card Mapping Database” refers to a feature of the present invention which is operated as a service or system to manage a consumer alias such as phone number or email address and a list of associated MasterCard primary account numbers (“PANs”). The Mapping Service is used to allow Senders to transfer money to Recipients securely without needed to know the Recipient's PAN. As used herein, the term “MoneySend APIs” refer to a set of services used by the OIs and RIs to support a MoneySend money transfer pursuant to some embodiments.

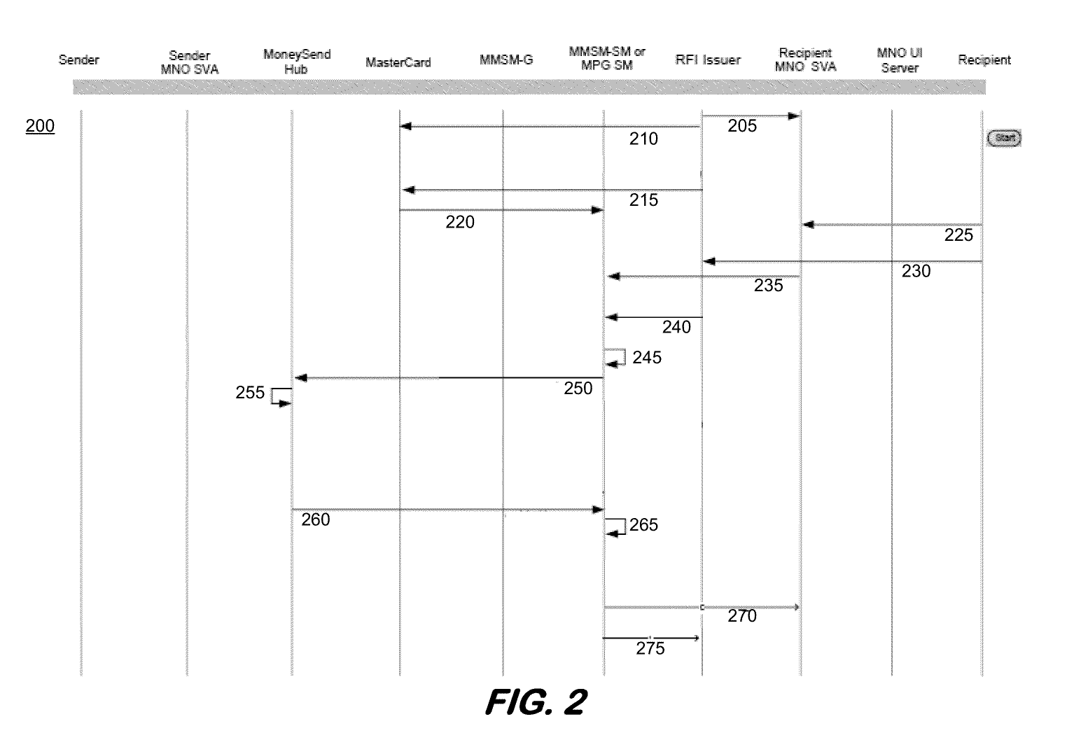

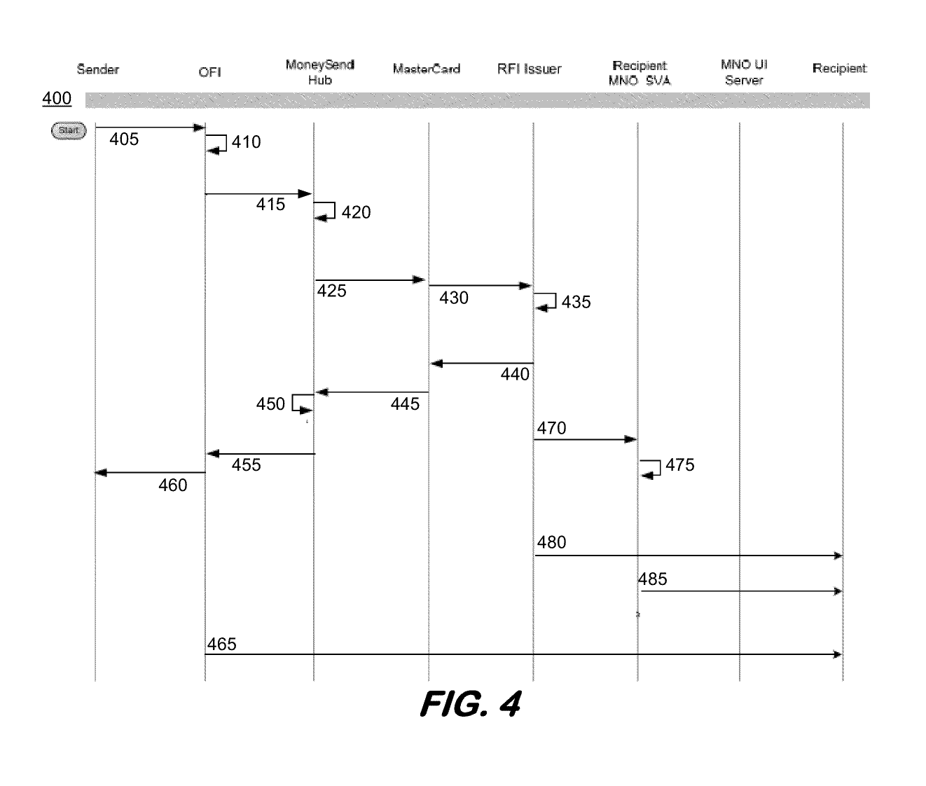

Features of some embodiments will be described in further details by referring to FIGS. 2 and 4. In those figures, a sending consumer (or “sender”) causes funds to be transmitted to a Recipient. Pursuant to the present disclosure, the Sender enjoys a number of benefits. For example, a Sender is able to send international remittances home to family/friends/ easily, quickly and safely by leveraging a the Recipients credit, debit or prepaid card to electronically transfer funds to a SVA or mobile wallet. The Sender need only provide the Recipient's mobile phone number to initiate the remittance, and may use any of a number of different funding sources, such as a deposit account, a payment card account, or cash. The Sender may access the remittance system via a number of different channels, including the internet, a mobile device, an Automated Teller Machine (“ATM”) or a kiosk. The funds are transferred promptly with sending bank able to provide certainty of timing independent of currency amount. The sender is notified when the recipient receives the funds.

Pursuant to some embodiments, the receiving consumer enjoys a number of benefits. For example, the Recipient may receive money conveniently and securely from a family, friends and others based cross border directly into a Mobile Wallet or SVA, linked to a prepaid, credit or debit card without having to go in-person to an agent location to retrieve funds or provide the PAN to the sender. To initiate a remittance, the Sender need only have the recipient's mobile phone number. The Recipient may receive the funds automatically in a default payment card account associated with the SVA (e.g., Mobile Wallet). In some embodiments, the funds are promptly made available by the receiving bank within a short time period (such as 30 minutes) of authorization. The recipient may be notified when funds have been sent to them and receives confirmation of funds delivered to account. Embodiments support various end points for international remittances including credit, debit and prepaid cards and cards linked to mobile NFC-enabled phones.

In both FIG. 2 and FIG. 4, a number of entities interact to upload data associated with recipients (FIG. 2) and conduct transactions (FIG. 4). In some embodiments, an entity such as MasterCard may operate a database (referred to herein for convenience as a Card Mapping database). In some embodiments, the database supports X-to-card (i.e., many to card) transactions through an API connection. An approved OI connects through the secure API and sends information that is used to initiate a payment transaction based on the recipient's card number provided. The Card Mapping database (e.g., MoneySend platform) submits the transaction to a payment network (e.g., such as the MasterCard Single Message System) on behalf of the OI so that the transaction can be routed to the card issuer (RFI) for approval and posting to the consumer account. Once the transaction is approved, clearing and settlement may occur through the normal MasterCard or other payment network provider process to move funds from the OFI to the RFI for benefit of the Recipient. Pursuant to some embodiments, the Card Mapping database further stores information about a receiving consumer (the “Recipient”) including the Recipient's card account number mapped to and alias information such as MSISDN or email address.

In some embodiments, person to person (P2P) transactions are supported that are initiated from a stored value account (referred to herein for convenience as, not as a limitation, a Mobile Money stored value account (MMSVA)) to another MMSVA within the same mobile network. In such transactions, the sender provides the Recipient's MSISDN linked with or associated with the Recipient's 16 digit PAN.

Pursuant to some embodiments, both domestic and cross-border transactions are supported, including but not limited to: (1) Registered to Registered—Domestic and cross-border P2P transfers between two registered consumers, and (2) Registered to Unregistered—Domestic P2P transfers from a registered consumer to an unregistered consumer.

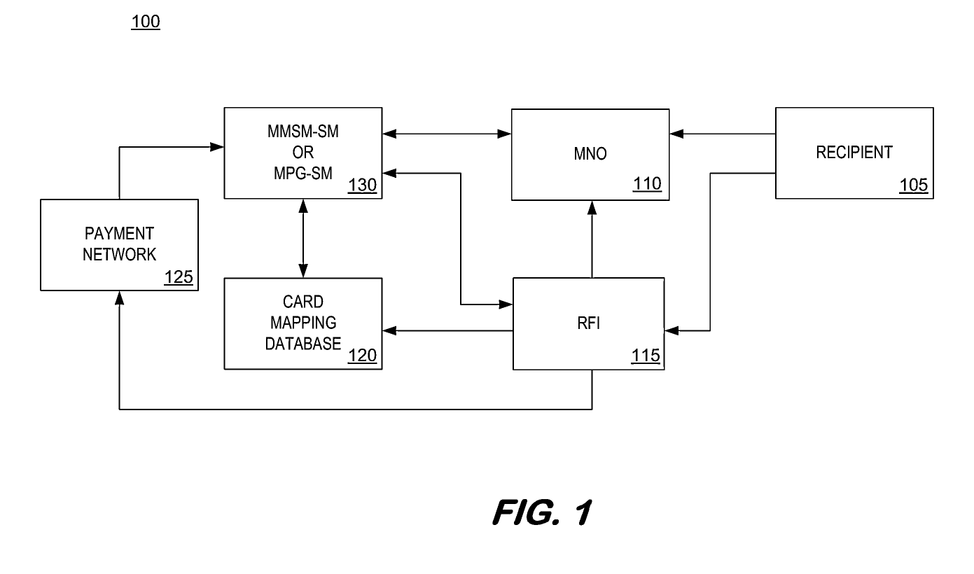

FIG. 1 is an illustrative system that may be used to support or otherwise facilitate some processes disclosed herein. In particular, system 100 may be a logical representation of a system that may support the uploading of Recipient data to a Card Mapping Database. FIG. 1 includes a Recipient 105, that may have a mobile telephone device (not separately shown) associated with a MSISDN and operating on a network provided by a MNO 110 that may provide/support a SVA for the Recipient. A RFI 115 is shown where the RFI may issue an account (PAN) to the Recipient that may be linked to the SVA. Further illustrated is a Card Mapping Database or service 120 (e.g., MoneySend platform). Further shown is a payment network 125 interconnected to the other components of FIG. 1. RFI 115 may operate to register with payment network 125 and MMSM-SM and MPG-SM 130.

FIG. 1 is a logical representation of a system and as such, the number and types of devices, systems, and sub-systems that may be used to implement such a system may vary from the depiction in FIG. 1. For example, one or more components of FIG. 1 may be combined and/or further divided.

Various interconnections are depicted in FIG. 1 to facilitate communication and transmission of data and information between the different components. In some aspects, the communication channels may include any communication protocols and networks, including those that may be necessary in accordance with any controlling regulations, laws, and standards related to the processes disclosed herein. System 100 may support, for example, the process flow depicted in FIG. 2.

Reference is now made to FIG. 2, where a process flow 200 for uploading recipient data to a Card Mapping Database is shown. More particularly, the process of FIG. 2 shows how recipient data may be uploaded to a Card Mapping Database. A “service manager” (shown as “MPG-SM”) may upload consumer registration data associated with participating issuers (e.g., RFI) into the Card Mapping Database (e.g., MoneySend Hub). This Database can then facilitate any number of MoneySend use cases where money is sent to a Recipient based on the Recipient's MSISDN. In process flow 200, a preliminary operation includes a receiving institution (“RFI”) that receives consent from a consumer (Recipient) that allows the consumer's information required for international mobile P2P services to be stored in a Card Mapping Database. At operation 205, the RFI assigns a PAN to a MNO SVA per MSISDN. The RFI further registers with the international remittance service provider (e.g., MasterCard) at operation 210. At step 215, the RFI registers the MMSM-SM or MPG-SM of the present example with the international remittance service provider. The international remittance service provider proceeds to register the participant with the MMSM-SM or the MPG-SM at operation 220 and provides an indication of such to the MMSM-SM or the MPG-SM. At step 225 or 230, the receiving consumer (i.e., the Recipient) registers their MSISDN with the MNO (step 225) or their PAN with the RFI (step 230) to receive remittances. In some aspects, step 230 assumes that the Recipient cardholder may opt-in to having their PAN being registered as part of process 200. In some embodiments, the Recipient cardholder may exercise an opt-out option. At steps 235 or 240, the respective MNO or RFI registers the Recipient and their corresponding MSISDN-PAN pair for the international remittance service herein with the MMSM-SM or MPG-SM.

Continuing with process 200, at step 245 the MMSM-SM or MPG-SM processes the consumer registration (or changes/deletes consumer registration) and validates that information including the MSISDN/PAN pair are present, and flags the consumer as a MoneySend registered, participating recipient. At 250, the MMSM-SM or MPG-SM initiates a new transaction type for the mapping database (e.g., the MoneySend Hub) web service request (e.g., “Card Mapping (Create)” API) to register a consumer (or change/delete a consumer registration) as a MoneySend recipient (e.g., this may be performed using an API such as that provided in the MasterCard Developer Zone for MoneySend Hub “Card Mapping (Create)” API as provided by the Assignee hereof. The MPG passes required data elements to the MoneySend Card Mapping Database (i.e., MoneySend Hub). In some embodiments, the following data elements may be used, although other data elements including substitute data elements and modifications of the following data elements are possible:
Issuer ICA,
MSISDN, (mandatory)
Funding Account or Card Alias,
PAN and Expiry Date,
Funding Account Cardholder Name,
Funding Account Cardholder Address.)

At operation 255, the Card Mapping Database performs data validation and registers, changes, or deletes the consumer with MSISDN/PAN data pair, in agreement with the request made at 250.

In some embodiments, at operation 260 the Card Mapping Database sends web service response to registration, change or delete request with the appropriate response code (for example, the MasterCard Developer Zone for MoneySend API responses and error codes may be used) to indicate, for example, whether the registration, change, or delete request was successfully processed or not. At operation 265, the MPG receives the Card Mapping Database web service response and records disposition, and updates registration database for consumer MoneySend recipient status.

In some embodiments, processing continues at steps 270 or 275 where the MMSM-SM or MPG-SM sends an advisement message to the RFI or MNO, respectively, based on success or failure of consumer registration, change, or delete per existing MMSM-SM or MPG SM registration process.

In some embodiments, exception handling may be performed with these messages. For example, the MPG may respond to create a registration request with the appropriate validation errors. In the case of other errors (such as timeout errors due to network downtime or API error, or duplicate API calls), the MPG may respond to a registration request with the appropriate error codes to the Participant. In the event of an already registered Recipient MSISDN, the MPG may pass the Card Mapping Database error message, “Consumer is already registered with MoneySend Service with another provider.”

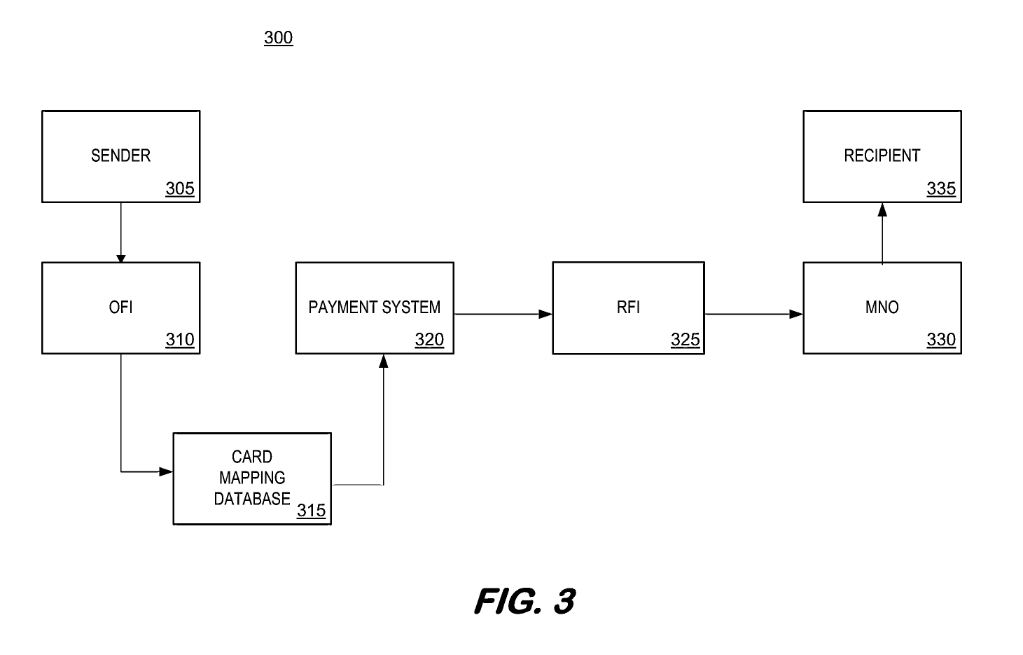

FIG. 3 is an illustrative system that may be used to support or otherwise facilitate some processes disclosed herein. In particular, system 300 may be a logical representation of a system that may support a transfer of funds (i.e., a remittance) in accordance with some aspects herein. FIG. 1 includes a Sender 305, that may originate a transfer request via any channel offered by the OFI 310. OFI 310 may communicate with a Card Mapping Database or service 315 (e.g., MoneySend platform) that operates to, for example, determine an account associated/mapped to the MSISDN provided by the Sender in the transfer request. Further shown is a payment network 320 that may operate to process and route authorization requests and responses in cooperation with RFI 325. The RFI may communicate with Recipient MNO 330 to transfer/credit funds to the Recipients SVA in accordance with the request from the Sender as authorized. RFI 325 may further operate to, for example, notify Recipient 335 of the transfer at their respective mobile telephone (not shown).

In some aspects, FIG. 3 is a logical representation of a system and as such, the number and type of devices, systems, and sub-systems that may be used to implement such a system may vary from the depiction in FIG. 3. For example, one or more components of FIG. 3 may be combined and/or further divided into other devices, systems, and sub-systems.

Various interconnections are depicted in FIG. 3 to facilitate communication and transmission of data and information between the different components. In some aspects, the communication channels may include any communication protocols and networks, including those that may be necessary in accordance with any controlling regulations, laws, and standards related to the processes disclosed herein. System 300 may support, for example, the process flow depicted in FIG. 4.

Reference is now made to FIG. 4 where a transaction flow 400 for a remittance in accordance with the present disclosure is illustrated. In some embodiments, process 400 may be implemented by system 300 disclosed in FIG. 3. The process 400 allows a consumer (Sender) to use any available channels provided by a participating financial institution (e.g., in-branch, ATM, online, mobile banking, kiosk, etc) to send money via a MoneySend Payment Transaction to a Recipient MNO SVA account that is linked to a payment card account, by providing the Recipient's MSISDN (rather than a card account number) as identification of the receiving consumer account.

In a process step 405, the consumer of an OI (“Sender”) initiates a transfer herein (e.g. Money Transfer) to the Recipient's MSISDN per an Originating Financial Institution (OFI) offered channel (eg. in-branch, ATM, online, mobile banking, etc.). At 410, the OFI initiates a funding transaction per OFI defined process and rules. At operation 415, the OFI initiates a Card Mapping Database “Transfer” web service request with recipient MSISDN per a Card Mapping Database defined API.

At 420, the Card Mapping Database performs a MSISDN/PAN mapping and PAN eligibility validation per the established rules of the Card Mapping Database (e.g., MoneySend platform). At step 425, if the MSISDN/PAN mapping and PAN eligibility validation was successful, the Card Mapping Database (e.g., MoneySend platform) initiates an authorization request (e.g., a MoneySend Payment Transaction 0200 Authorization Request) with linked funding transaction unique reference number to MasterCard's network in accordance with established procedures. In the event the MSISDN/PAN mapping and PAN eligibility validation was unsuccessful, then process flow 400 may proceed to step 450. At operation 430, the payment network (such as MasterCard) routes the authorization request (e.g., 0200 Payment Transaction Authorization Request) to a RFI, per MoneySend procedures. At 435, the Receiving Financial Institution (RFI) processes the authorization request (e.g., the Payment Transaction Authorization Request) per established procedures and processes. At operation 440, the RFI routes the authorization response (e.g., 0210 Payment Transaction Authorization Response) to the payment network (e.g.MasterCard's network) per established procedures. Processing continues at operation 445 that includes the payment network (e.g., MasterCard) routing an authorization response (e.g., 0210 Payment Transaction Authorization Response) to the Card Mapping Database.

At 450, the Card Mapping Database (e.g., MoneySend platform) logs transaction data and disposition, and at operation 455 the Card Mapping Database (e.g., MoneySend platform) sends “Transfer” API disposition to the OFI. The OFI passes the money transfer response to the Sender at 460.

In some embodiments, an optional operation may occur at 465 where, if approved, the OFI initiates transmission of an SMS (or other message or notification type) disposition message to the Recipient MSISDN.

At operation 470, the RFI issuer sends an advisement message to the Recipient MNO SVA system to credit the Recipient SVA account. At 475, the MNO then operates to validate the Recipient account and credits the Recipient SVA account. At operation 480, the RFI issuer initiates SMS disposition message to recipient MSISDN. Alternatively, the Receiving MNO SVA system initiates transmission of an SMS disposition message to the recipient MSISDN at operation 485.

In some embodiments, exception handling may be performed for the Bank to MNO SVA processing herein (e.g., process 400). For example, duplicate errors, validation errors, and timeout errors may follow existing MoneySend exception handling rules. In some embodiments, reports may be generated to capture the number of registered MoneySend Recipients, per Participant, number of money transfer transactions, the amount remitted, and other aspects of the transactions(s).

In some embodiments herein, the remittance system may allow senders to access the system and initiate funds transfers by use of the senders' mobile telephones. Further convenience may be provided by allowing the senders to identify the recipients of the funds transfers by the recipients' mobile telephone numbers. The remittance system may include capabilities for translating the recipients' mobile telephone numbers into the recipients' payment card account numbers, for the purpose of routing the funds transfers through the payment system.

In some embodiments, the institutional architecture that underlies the remittance system may include mobile network operators (MNOs) cooperating with financial institutions/payment card account issuers in many countries, with an international payment system to interlink the financial institutions. The payment system may be an existing system, like MasterCard's for example.

In some embodiments, tools and administrative capabilities will be provided on one or more servers or systems which allow a sponsor or participant to upload Mobile Wallet consumer information stored at or accessible to an MPG to the Card Mapping Database. For example, tools may be provided to enable an MPG to upload, edit or delete Consumer (Recipient) registration data associated with participating issuers (RIs) into the Card Mapping Database. The database will store the data elements such as the Consumer's PAN, the associated alias such as the MSISDN or the Email address and any other consumer information required per the relevant country or region's regulations and comply with the local laws to enable the cross-border remittances. This Database can be used to then facilitate remittance uses cases where funds can be remitted to the Recipient's Mobile Money MSISDN.

In still other embodiments, the payment system may include convenient features that allow senders to receive advance estimates of the effects of currency conversions on proposed funds transfers or other transactions. Other convenient features may aid recipients of funds transfers in finding nearby locations to access the transferred funds.

Remittance systems such as those described herein may leverage existing payment systems to provide previously unavailable efficiencies, cost-effectiveness and convenience, while also facilitating regulatory compliance by participating financial institutions (FIs) and RSPs.

The flow charts and descriptions thereof herein should not be understood to prescribe a fixed order of performing the method steps described therein. Rather the method steps may be performed in any order that is practicable.

As used herein and in the appended claims, the term “payment card account” includes a credit card account or a deposit account that the account holder may access using a debit or prepaid card. The term “payment card account number” includes a number that identifies a payment card account or a number carried by a payment card, or a number that is used to route a transaction in a payment system that handles debit card, prepaid and/or credit card transactions. The term “payment card” includes a credit card, prepaid or a debit card.

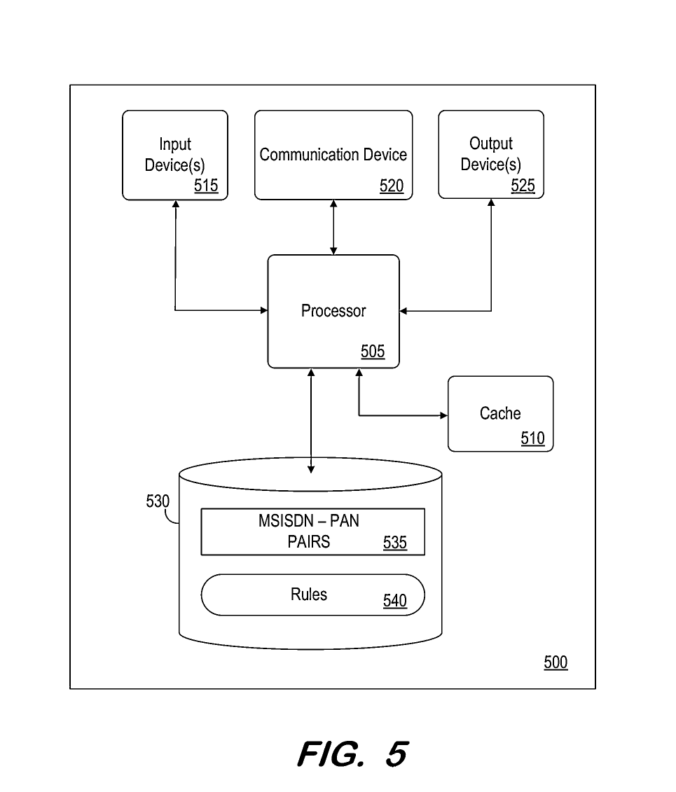

FIG. 5 is a block diagram overview of a system or apparatus 500 according to some embodiments. System 500 may be, for example, associated with any of the devices described herein, including for example a Card Mapping Database or service of FIGS. 1 and 3 (e.g., 120 and 315), in accordance with processes disclosed herein. System 500 comprises a processor 505, such as one or more commercially available Central Processing Units (CPUs) in the form of one-chip microprocessors or a multi-core processor, coupled to a communication device 520 configured to communicate via a communication network (not shown in FIG. 5) to another device or system (e.g., a RFI, MNO, etc.). In the instance system 500 comprises a device or system (e.g., supporting a cross-border remittance platform), communication device 520 may provide a mechanism for system 500 to interface with a payment network provider, a MNO, and other components disclosed herein. System 500 may also include a cache 510, such as RAM memory modules. The system may further include an input device 515 (e.g., a touchscreen, mouse and/or keyboard to enter content) and an output device 525 (e.g., a touchscreen, a computer monitor to display, a LCD display).

Processor 505 communicates with a storage device 530. Storage device 530 may comprise any appropriate information storage device, including combinations of magnetic storage devices (e.g., a hard disk drive), optical storage devices, solid state drives, and/or semiconductor memory devices. In some embodiments, storage device 530 may comprise a database system, including in some configurations an in-memory database.

Storage device 530 may store program code or instructions 535 that may provide processor executable instructions to, for example, manage data validations and registrations of MSISDN-PAN pairs, in accordance with processes herein. Processor 505 may perform the instructions of the program instructions 535 to thereby operate in accordance with any of the embodiments described herein. Program instructions 535 may be stored in a compressed, uncompiled and/or encrypted format. Program instructions 535 may furthermore include other program elements, such as an operating system, a database management system, and/or device drivers used by the processor 505 to interface with other components and devices (not shown in FIG. 5). Storage device 530 may also include data 540 such as rules related to the processes disclosed in some embodiments herein. Data 540 may be used by system 500, in some aspects, in performing one or more of the processes herein, including individual processes, individual operations of those processes, and combinations of the individual processes and the individual process operations.

All systems and processes discussed herein may be embodied in program code stored on one or more tangible, non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Although the present invention has been described in connection with specific exemplary embodiments, it should be understood that various changes, substitutions, and alterations apparent to those skilled in the art can be made to the disclosed embodiments without departing from the spirit and scope of the present disclosure as set forth in the appended claims.

What is claimed is:

1. A method implemented by a computing system in response to execution of program instructions by a processor of the computing system, the method comprising:
receiving a request for a funds transfer to transfer funds from Sender to a Recipient, the request including a transfer amount and, as an identifier of the recipient, a destination mobile telephone number associated with the recipient;
translating, based at least in part on a record of a mapping of the destination mobile telephone number to an account associated with the recipient, the destination mobile telephone number to a destination account number; and
routing the funds transfer as a payment transaction using the destination account number.

2. The method of claim 1, further comprising determining whether the destination mobile telephone number associated with the recipient is eligible to receive the funds transfer.

3. The method of claim 1, wherein the routing of the funds transfer as a payment transaction using the destination account number comprises:
generating an authorization request;
transmitting the authorization request to a receiving issuer associated with the destination account number of the recipient; and
receiving an authorization response from the receiving issuer in reply to the authorization request.

4. The method of claim 1, wherein the request is received from an originating issuer on behalf of the sender.

5. The method of claim 4, wherein a response to the request is transmitted to the originating issuer.

6. The method of claim 1, further comprising sending a notification of a response to the request to the destination mobile telephone number associated with the recipient.

7. A method implemented by a computing system in response to execution of program instructions by a processor of the computing system, the method comprising:
receiving a request to register a recipient with a funds transfer service to enable the recipient to receive a transfer of funds from a sender in reply to a transfer funds request that identifies the recipient by a destination mobile telephone number associated with the recipient, the request to register the recipient including an indication of the destination mobile telephone number;
creating a record of a mapping of the destination mobile telephone number to an account associated with the recipient; and
transmitting a response to the request to register the recipient, the response including an indication of whether the request to register the recipient succeeded.

8. The method of claim 7, further comprising registering a receiving issuer associated with an account associated with the recipient, the account being mapped to the destination mobile telephone number.

9. The method of claim 1, wherein the request to register the Recipient includes an indication of a mapping of the destination mobile telephone number to an account associated with the destination mobile telephone number.

10. The method of claim 9, wherein the request to register the Recipient is received from at least one of a receiving issuer associated with the account associated with the recipient and a mobile network operator supporting service of the destination mobile telephone number.

11. The method of claim 7, wherein the response to the request to register the Recipient is transmitted to at least one of a receiving issuer associated with the account associated with the recipient and a mobile network operator supporting service of the destination mobile telephone number.

12. The method of claim 7, wherein a receiving issuer assigns an account number to a mobile network operator providing supporting service of the destination mobile telephone number per a destination account associated with the destination mobile telephone number.

13. The method of claim 12, wherein the destination account associated with the destination mobile telephone number is a stored value account.
